(19) United States
(12) Patent Application Publication
(10) Pub. No.: US 2002/0179112 A1
(43) Pub. Date: Dec. 5, 2002

(54) Method of cleaning electronic device

(76) Inventor: Lenardus Cornelus Robertus Winters, Nijmegen (NL)

Correspondence Address: Philips Corporation, Intellectual Property Department, 580 White Plains Road, Tarrytown, NY, 10591, US

(21) Appl. No.: 10/148,461

(22) PCT Filed: Oct. 1, 2001
(86) PCT No.: PCT/EP01/11391

(30) Foreign Application Priority Data
Oct. 5, 2000 (EP) 00203441.1

(51) Int. Cl. C23G 1/00; C03C 23/00

(52) U.S. Cl. 134/2; 134/6; 134/30

(57) ABSTRACT

A method of manufacturing an electronic device, in particular but not exclusively a semiconductor device, in which method a substrate (2) is placed inside a process chamber (1) and a surface (3) of the substrate (2) is subjected to a cleaning process sequence comprises the steps of:

subjecting the surface (3) of the substrate (2) to a wet cleaning treatment,

purging the process chamber (1) with an inert gas while keeping the surface (3) of the substrate (2) wet,

drying the surface (3) of the substrate (2).

The invention relates to a method of manufacturing an electronic device, in particular but not exclusively a semiconductor device, in which method a substrate is placed inside a process chamber and a surface of the substrate is subjected to a cleaning process sequence.

During the manufacture of an electronic device such as a semiconductor device, the surface of the substrate is exposed to potential contamination sources. In order to run a stable production process there is a necessity for a clean surface of the substrate. Therefore, to establish a low baseline contamination level, cleaning process sequences are commonly used. An important criterion of a ‘good’ cleaning process sequence is that besides removing contaminants the addition of contaminants e.g. particles is reduced to a minimum.

Frequently used cleaning process sequences in the semiconductor industry make use of a wet cleaning treatment on the basis of dilutions of hydrochloric acid, ammonia hydrofluoric acid and/or sulfuric acid, which wet cleaning treatment is carried out in sequential cleaning steps (hereinafter also called multi-step wet cleaning treatment). It is known that vapors of such chemicals react to form solid products (particles) such as ammonium chloride, ammonium fluoride, ammonium sulfate, etc. Another frequently used cleaning process sequence makes use of the so-called RCA cleaning treatment, which is a multi-step wet cleaning treatment comprising four cleaning steps: 1) removal of organic contamination using a sulfuric acid and hydrogen peroxide mixture; 2) removal of oxide films with a mixture of water and hydrofluoric acid; 3) removal of particles and re-oxidation of hydrophobic silicon surfaces using a mixture of water, hydrogen peroxide, and ammonium hydroxide; 4) removal of metals with a mixture of water, hydrogen peroxide, and hydrochloric acid.

In the above cases solid products (particles) will arise from reaction between the vapors of the chemicals used in one and the same cleaning step and from reaction between vapors of chemicals used in different cleaning steps.

The above particle generation is especially a problem in cleaning tools, such as spray tools, where the cleaning step(s) is/are performed in the same process chamber as the drying step. During drying of the substrates, the solid products (particles) adhere to the dry surface of the substrates. This causes an increase in the surface particle number. In current cleaning process sequences, the disadvantageous effect of these solid products on the surface particle number is counteracted by, prior to drying the substrates, rinsing the substrates and/or moving the substrates to another process chamber.

A method of the kind mentioned in the opening paragraph is known from WO 99/52654. After the substrates have been subjected to a wet cleaning treatment, the substrates are subjected to a rinse, for example, by spraying them with a flow of deionized water, and subsequently dried by subjecting them to any one or more known drying techniques, such as spin drying while purging nitrogen gas.

A disadvantage of the known method is that the rinse is not very effective in removing the solid products (particles) from the process chamber. As a consequence, a substantial part of the particles is still present in the process chamber once the rinse is completed. Due to the high rotation speeds applied during the subsequent spin drying, the substrates are dried very rapidly thereby causing adhesion of the remaining solid products (particles) on the surface of the substrates once the surface of the substrates is dry. The time between the start of the nitrogen purge and the moment the surface of the substrates is dry is too short to accomplish substantial removal of the solid products from the process chamber.

The invention has inter alia for its object to provide a method of the kind mentioned in the opening paragraph, in which method the performance of the cleaning process sequence is improved.

The cleaning process sequence of the method in accordance with the invention therefore comprises the steps of:

subjecting the surface of the substrate to a wet cleaning treatment,

purging the process chamber with an inert gas while keeping the surface of the substrate wet,

drying the surface of the substrate.

A significant reduction in the surface particle number is achieved when, prior to drying the surface of the substrate, the process chamber is purged with an inert gas while keeping the surface of the substrate wet. As the surface of the substrate is kept wet during purging the process chamber, the chance that solid products (particles) present therein adhere on the surface of the substrate is reduced. Hence, by implementing the above-mentioned purging step, the surface particle number can be reduced. The time needed for purging depends inter alia on the size of the process chamber, the flow of inert gas used, and the initial and the desired concentration level of particles in the process chamber. It will be clear to a person skilled in the art that the longer the process chamber is being purged while keeping the surface of the substrates wet, the lower the ultimate concentration level of particles in the process chamber will be.

In order to reduce the amount of excessively applied liquid, the surface of the substrate is advantageously kept wet by spraying a liquid onto the surface of the substrate. Spraying is an effective way for wetting a surface.

In order to increase the spraying efficiency further, the substrate is advantageously rotated while spraying the liquid onto its surface. The rotation promotes an even distribution of the liquid over the surface of the substrate.

Further advantageous embodiments of the method in accordance with the invention are described in the other dependent claims.

These and other aspects of the invention will be apparent from and be elucidated with reference to the embodiments described hereinafter and shown in the drawing. In the drawing:

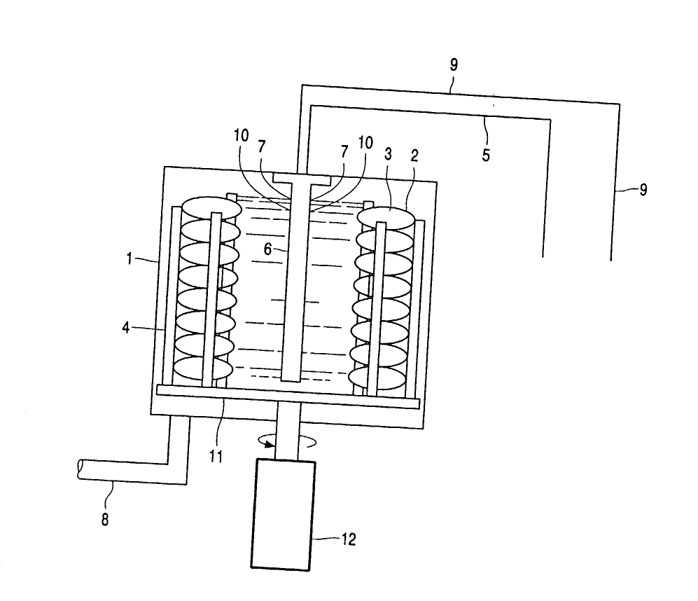

FIG. 1 shows in diagrammatic view an apparatus for carrying out the method in accordance with the invention.

An apparatus for subjecting a surface 3 of substrates 2 to a cleaning process sequence is shown schematically in FIG. 1, the apparatus comprising a process chamber 1 for accommodating the substrates 2. In the present example, the process chamber 1 is designed such that a large number of substrates 2 can be treated simultaneously by stacking the substrates 2 in cassettes 4. Alternatively, the apparatus may comprise a process chamber 1 designed to treat one substrate 2 a time.

First, the surface 3 of the substrates 2 is subjected to a wet cleaning treatment, for example the earlier mentioned RCA wet cleaning treatment comprising the following cleaning steps: 1) removal of organic contamination using a sulfuric acid and hydrogen peroxide mixture; 2) removal of oxide films with a mixture of water and hydrofluoric acid; 3) removal of particles and re-oxidation of hydrophobic silicon surfaces using a mixture of water, hydrogen peroxide, and ammonium hydroxide; 4) removal of metals with a mixture of water, hydrogen peroxide, and hydrochloric acid. This wet cleaning treatment is carried out in the apparatus shown in FIG. 1 in a conventional way.

After this wet cleaning treatment, the process chamber 1 is purged with an inert gas while keeping the surface 3 of the substrates 2 wet. In order to keep the surface 3 of the substrates 2 wet, a liquid is supplied to the process chamber 1 via supply line 5, which liquid is then provided onto the surface 3 of the substrates 2. For this purpose, the supply line 5 terminates in a spray post 6, from which spray post 6 the liquid is sprayed laterally from a series of nozzles 7 onto the surface 3 of the substrates 2. The spray post 6 extends downward in the center of the process chamber 1 such that all the substrates 2 in the cassettes 4 can be sprayed with the liquid. Excessively supplied liquid leaves the process chamber 1 through a drain 8 positioned at the bottom of the process chamber 1. In order to purge the process chamber 1, an inert gas is supplied to the process chamber 1 via a further supply line 9, which inert gas enters the process chamber 1 via a further series of nozzles 10 provided in the spray post 6. To increase the spraying efficiency with regard to wetting the surface 3 of the substrates 2, the substrates are advantageously rotated while spraying the liquid onto the surface of the substrates. The cassettes 4 containing the substrates 2 can be rotated by means of a turntable 11, which is used in conjunction with a motor 12. Deionized water is advantageously applied as the liquid and nitrogen gas is advantageously applied as the inert gas. Deionized water and nitrogen gas are fluids that are commonly applied in such apparatus. It will be evident, however, that other liquids and inert gases may be used instead.

As the surface of the substrates is kept wet during purging the process chamber, the chance that solid products (particles) present therein adhere on the surface of the substrates is reduced. Hence, by implementing the above-mentioned purging step the surface particle number can be reduced. The time needed for purging depends inter alia on the size of the process chamber, the flow of inert gas used, and the initial and the desired concentration level of particles in the process chamber. It will be clear to a skilled person that the longer the process chamber is being purged while keeping the surface of the substrates wet, the lower the ultimate concentration level of particles in the process chamber will be.

Prior to drying the surface 3 of the substrates 2, the substrates may be subjected to one or more rinsing steps. The surface 3 of the substrates 2 is then dried. This can be done by using any one or more known drying techniques, such as rotating the substrates or rotating the substrates while purging the process chamber with a further inert gas, such as nitrogen gas. As the concentration of solid products (particles) inside the process chamber 1 has been effectively reduced by means of the aforementioned purging step, the chance of adhesion of particles on the surface 3 of the substrates 2 once the surface of the substrates has become dry is reduced.

The invention can be advantageously applied for, for example, the removal of organic materials including photoresists and organic contaminants, the removal of metals, salts of metals, particles, and the removal of oxide and regeneration of a controlled chemical oxide.

Although the invention can be advantageously applied in relation to multi-step wet cleaning treatments, it is of course also applicable to single-step wet cleaning treatments, that is wet cleaning treatments comprising just one cleaning step, such as the wet etching of silicon oxide with a hydrofluoric acid solution. Besides for etching of silicon oxide, hydrofluoric acid solutions can also be used for etching of, for example, silicon nitride and silicon oxynitride.

Although the invention can be advantageously used in the manufacture of semiconductor devices, which are also referred to as active devices, it is also applicable for the benefit of passive devices such as, for example, thin-film capacitors and resistors. Besides to substrates comprising semiconductor bodies, which are commonly applied in the manufacture of semiconductor devices, the invention is also applicable to substrates comprising, for example, glass bodies or silicon-on-insulator (SOI) bodies. Glass bodies can be used in the manufacture of, for example, thin-film transistors and active arrays for driving liquid crystal displays (LCD's), whereas silicon-on-insulator (SOI) bodies can be used for high-frequency devices for e.g. telecom applications and high-voltage devices.

It will be apparent that the invention is not limited to the embodiments described above, but that many variations are possible to those skilled in the art within the scope of the invention.

1. A method of manufacturing an electronic device, in particular but not exclusively a semiconductor device, in which method a substrate is placed inside a process chamber and a surface of the substrate is subjected to a cleaning process sequence comprising the steps of:
subjecting the surface of the substrate to a wet cleaning treatment,
purging the process chamber with an inert gas while keeping the surface of the substrate wet,
drying the surface of the substrate.

2. A method as claimed in claim 1, wherein the surface of the substrate is kept wet by spraying a liquid onto the surface of the substrate.

3. A method as claimed in claim 2, wherein deionized water is applied as the liquid.

4. A method as claimed in claim 2 or 3, wherein the substrate is rotated while spraying the liquid onto the surface of the substrate.

5. A method as claimed in any one of the preceding claims, wherein nitrogen gas is applied as the inert gas.

6. A method as claimed in any one of the preceding claims, wherein the surface of the substrate is dried by means of rotating the substrate.

7. A method as claimed in claim 6, wherein the process chamber is purged with a further inert gas while rotating the substrate to dry the surface thereof.

8. A method as claimed in claim 7, wherein nitrogen gas is applied as the further inert gas.

9. A method as claimed in any one of the preceding claims, wherein the wet cleaning treatment is carried out by performing a sequence of cleaning steps.

10. A method as claimed in any one of the preceding claims, wherein the cleaning process sequence is carried out in a spray tool.
